(19) United States
(12) Patent Application Publication
(10) Pub. No.: US 2026/0084625 A1
(43) Pub. Date: Mar. 26, 2026

(54) EXTERNALLY CONNECTED CARGO TOOL FOR VEHICLE

(71) Applicant: Ningbo Innrack Technology Co., Ltd., Ningbo (CN)

(72) Inventor: Yufeng WANG, Ningbo (CN)

(73) Assignee: Ningbo Innrack Technology Co., Ltd., Ningbo (CN)

(21) Appl. No.: 18/900,909

(22) Filed: Sep. 30, 2024

(30) Foreign Application Priority Data
Sep. 23, 2024 (CN) 202422319707.0

(51) Int. Cl. B60R 9/00

(52) U.S. Cl. CPC B60R 9/00

(57) ABSTRACT

The present invention discloses an externally connected cargo tool for a vehicle, including a connecting assembly, a support assembly, and an eccentric assembly disposed therebetween. The eccentric assembly includes an eccentric member and an eccentric drive member. Two ends of the eccentric member are rotatably connected to the support assembly, and a middle portion of the eccentric member abuts against the connecting assembly. The eccentric drive member is configured to drive the eccentric member to rotate, eliminating a wear gap at an abutment between the eccentric member and the connecting assembly, thereby resolving the problem of poor stability due to wear at a joint between the cargo tool and the vehicle when the cargo tool carries goods.

### BACKGROUND

### 1. Technical Field

The present invention relates to the technical field of vehicle cargo accessories, specifically to an externally connected cargo tool for a vehicle.

### 2. Background Information

In modern travel and leisure activities, large sports devices such as bicycles and snowboards are indispensable to carry. These devices are typically transported by fixing them onto a cargo tool, such as a bicycle rack. Specifically, in the conventional method, the bicycle rack is designed to be mounted on the roof or trunk of the vehicle, or to be fixed using a suspension means, aiming to effectively utilize the external space of the vehicle, and facilitating long-distance travel or daily carrying.

These designs resolve the carrying problems to some extent, but the cargo tool is exposed to the outside for a long time, and the vehicle bumps and shakes during driving. As a result, the joint between the cargo tool and the vehicle is subjected to wear due to vibrations and external environmental factors (for example, rain and dust). The wear affects the stability and safety of the cargo tool and may shorten the service life, increasing the user's maintenance costs.

### BRIEF SUMMARY

To resolve the technical problem, the present invention provides an externally connected cargo tool for a vehicle, resolving the problem of poor stability due to wear at a joint between the cargo tool and the vehicle when the cargo tool carries goods.

The technical solution of the present invention is described as follows:

An externally connected cargo tool for a vehicle is provided, including:

a connecting assembly, a support assembly, and an eccentric assembly disposed therebetween, the connecting assembly is rotatably connected to and abuts against the support assembly, the eccentric assembly includes an eccentric member and an eccentric drive member, two ends of the eccentric member are both connected to the support assembly, and a middle portion of the eccentric member abuts against thee connecting assembly; and

the eccentric drive member is connected to both the support assembly and the eccentric member, and the eccentric drive member is configured to drive the eccentric member to rotate, eliminating a wear gap at an abutment between the eccentric member and the connecting assembly.

In a possible implementation, the eccentric member includes an eccentric shaft, the eccentric shaft is provided with at least two outer shafts and an inner shaft between adjacent two of the outer shafts, an axis of the inner shaft is eccentrically arranged with respect to an axis of the outer shaft, the outer shaft is configured to be rotatably connected to the support assembly, and the inner shaft is configured to abut against the connecting assembly.

In a possible implementation, the support assembly includes at least two side plates parallel to each other, the side plate is provided with a gap eliminating rotation hole, the eccentric shaft perpendicularly passes through the gap eliminating rotation hole, and the outer shaft is rotatably disposed in the gap eliminating rotation hole.

In a possible implementation, the connecting assembly includes at least one abutment plate, the abutment plate is disposed between two of the side plates, and the abutment plate is provided with an abutment notch.

A rotary curved surface is provided around a circumferential side of the inner shaft, when the eccentric shaft is rotated such that the rotary curved surface is opposite the abutment notch, an abutment between the support assembly and the inner shaft is eliminated, and the support assembly is rotatably connected to the connecting assembly so as to adjust a placement angle.

In a possible implementation, the support assembly further includes a support base plate disposed between two of the side plates, and two ends of the support base plate are each provided with a support protruding arm.

The side plate is provided with a support hole, the support protruding arm is clamped in the support hole, the support base plate abuts against a lower end surface of the abutment plate, and the support base plate is configured to support the weight of the support assembly.

In a possible implementation, a gap-eliminating abutment surface is also provided on the circumferential side of the inner shaft, and the gap-eliminating abutment surface is used for abutting against the abutment notch.

In a possible implementation, the eccentric drive member includes a drive torsion spring, the drive torsion spring is disposed on an outer side of the side plate, the drive torsion spring sleeves an end of the outer shaft, and the drive torsion spring is configured to drive the eccentric shaft to rotate along a first direction, such that the inner shaft rotates to eliminate a wear gap.

In a possible implementation, an abutment start point and an abutment end point are provided on the gap-eliminating abutment surface, when the abutment start point abuts the abutment notch, a gap eliminating distance is 0 mm, and when the eccentric shaft rotates, enabling the abutment end point to abut the abutment notch, the gap eliminating distance is 3 mm.

In a possible implementation, the drive torsion spring has one end provided with a first limiting hook and the other end provided with a second limiting hook, the first limiting hook is fixedly connected to the side plate, and the second limiting hook is fixedly connected to the outer shaft.

In a possible implementation, the eccentric drive member further includes a manual lever, the manual lever is connected to another end of the eccentric shaft, and the manual lever is configured to shake the eccentric shaft, enabling the eccentric shaft to rotate along a second direction.

According to the above solution, the present invention has the following beneficial effects: An externally connected cargo tool for a vehicle includes a connecting assembly connected to the vehicle, a support assembly for placing a device, and an eccentric assembly disposed therebetween. An eccentric drive member drives an eccentric member to rotate, thereby eliminating a wear gap at the abutment between the eccentric member and the connecting assembly, reducing the risk of a gap at the joint of the structure of the cargo tool itself due to wear between structures. The present invention improves the structural stability of the cargo tool itself through the structural arrangement of the eccentric member and the eccentric drive member, thereby enhancing the safety of transporting a large device with the vehicle.

### BRIEF DESCRIPTION OF THE DRAWINGS

FIG. 1 is a schematic structural diagram of an externally connected cargo tool for a vehicle according to the present invention.

FIG. 2 is an exploded diagram of the externally connected cargo tool for a vehicle according to the present invention.

FIG. 3 is an enlarged view of part A in FIG. 2 of the externally connected cargo tool for a vehicle according to the present invention.

FIG. 4 is a schematic structural diagram of an eccentric shaft and a side plate in the externally connected cargo tool for a vehicle according to the present invention.

FIG. 5 is a schematic structural diagram of a usage scenario of the externally connected cargo tool for a vehicle according to the present invention.

In the figure:

10. connecting assembly; 11. abutment plate; 111. abutment notch; 20. support assembly; 21. side plate; 211. gap eliminating rotation hole; 212. support hole; 213. hook hole; 22. support base plate; 221. support protruding arm; 30. eccentric assembly; 31. eccentric member; 311. eccentric shaft; 3111. outer shaft; 3112. inner shaft; 3113. rotary curved surface; 3114. gap-eliminating abutment surface; 3115. abutment start point; 3116. abutment end point; 32. eccentric drive member; 321. drive torsion spring; 3211. first limiting hook; 3212. second limiting hook; 322. manual lever; 323. isolation plate; 324. fixed plate; 325. torsion-spring fixing bolt; 34. first direction; 35. second direction; and 40. rotational structure.

### DETAILED DESCRIPTION OF THE DRAWINGS AND THE PRESENTLY PREFERRED EMBODIMENTS

The present invention is further described below with reference to the accompanying drawings and implementations:

It should be noted that when individuals transport large sports devices such as bicycles and snowboards, they usually need to use a cargo tool mounted on the outer portion of the vehicle. For example, they mount a bicycle rack on the roof of the vehicle, and then fix the bicycle on the bicycle rack. However, due to the long-term exposure of the existing bicycle rack to the outside, and factors such as bumps during vehicle driving, the structure of the bicycle rack is prone to wear, reducing the structural stability of the bicycle rack itself and the safety of the vehicle transporting the bicycle. Therefore, the present invention provides an externally connected cargo tool for a vehicle, thereby alleviating the above defects by changing the structure of the bicycle rack itself.

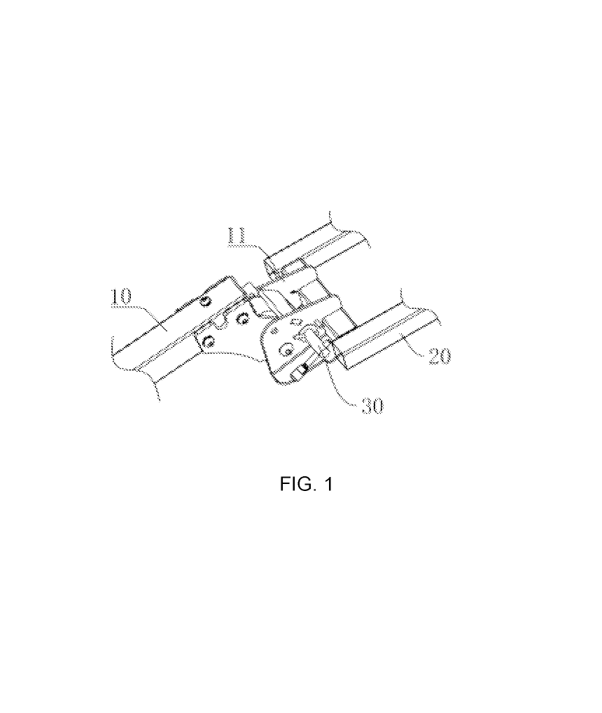

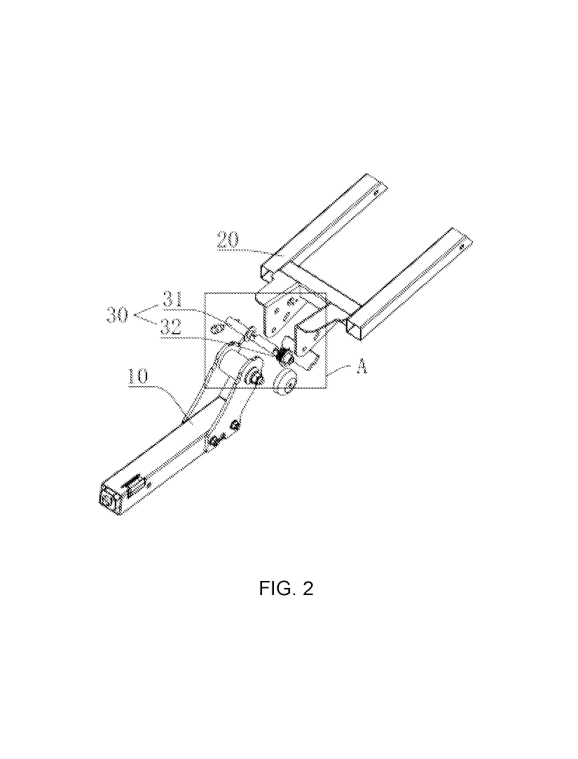

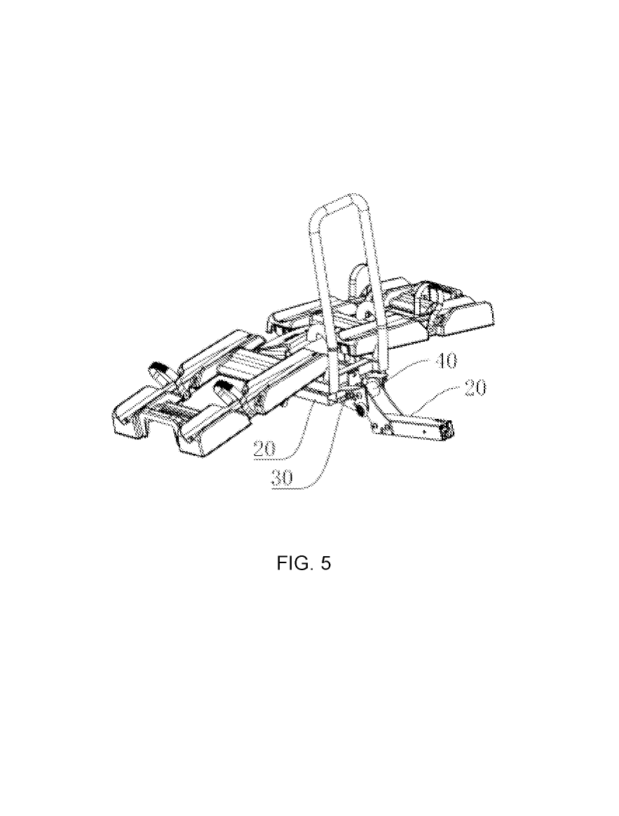

Referring to FIGS. 1 to 5, the present invention provides an externally connected cargo tool for a vehicle. Specifically, the externally connected cargo tool includes a connecting assembly, a support assembly, and an eccentric assembly disposed therebetween. The connecting assembly has one end provided with a connecting structure, which is fixedly connected to a trailer bar at the trunk of the vehicle. The other end of the connecting assembly is rotatably connected to and abuts against the support assembly. In this embodiment, the support assembly is provided with a fixing base for fixing a bicycle, thereby supporting and suspending the support assembly and the bicycle at the rear of the vehicle via the connecting assembly. This facilitates the transportation of large sports devices such as bicycles and snowboards. Additionally, the eccentric assembly includes an eccentric member and an eccentric drive member. Further, specifically, both ends of the eccentric member are rotatably connected to the other end of the support assembly, and the middle portion of the eccentric member abuts against the connecting assembly. It should be noted that the connecting assembly supports the support assembly upwards by abutting against the lower end surface of the support assembly. The eccentric member limits the upward movement of the connecting assembly at an abutment between its middle portion and the connecting assembly. The eccentric drive member is located at one end of the eccentric member and is fixedly connected to both the support assembly and the eccentric member. The eccentric drive member is configured to drive the eccentric member to rotate, thereby eliminating the wear gap at the abutment between the eccentric member and the connecting assembly. This reduces the risk of a gap forming at the structural joint of the cargo tool itself due to wear between structures. Thus, in the present invention, the structural arrangement of the eccentric member and the eccentric drive member enhances the structure stability of the cargo tool, improving the safety during the transport of large equipment with the vehicle.

It should be understood that through the rotation of the eccentric member, the wear gaps at the abutments between the connecting assembly and the support assembly, as well as between the eccentric member and the connecting assembly, can be simultaneously eliminated. However, due to the action of gravity, the connecting assembly is always in contact with the support assembly. Therefore, it is only necessary to eliminate the gap at the abutment between the upper eccentric member and the connecting assembly to improve the stability of the connected structures.

In some embodiments, referring to FIGS. 1 to 3, the eccentric member includes an eccentric shaft. The eccentric shaft is provided with at least two outer shafts and an inner shaft located between adjacent two of the outer shafts. In this embodiment, the eccentric shaft is provided with three outer shafts and two inner shafts. The axis of the inner shaft is eccentrically arranged with respect to the axis of the outer shaft. The inner shaft has a diameter of 13 mm, and the outer shaft has a diameter of 16 mm. Specifically, the two outer shafts on the outer side are both rotatably connected to the support assembly, and the inner shaft abuts against the connecting assembly. Thus, the inner shaft abuts against the lower part of the connecting assembly. Additionally, the eccentric drive member is fixedly connected to the outer shaft, such that the eccentric drive member drives the eccentric member to rotate, so as to change the placement position of the inner shaft. As the inner shaft is eccentric with respect to the outer shaft, the inner shaft can exert an upward force on the lower part of the connecting assembly, eliminating the wear gap between the connecting assembly and the support assembly.

Further, referring to FIGS. 1 to 3, the support assembly includes at least two side plates parallel to each other. The side plates are provided with gap eliminating rotation holes. The eccentric shaft is perpendicular to the side plate and penetrates the gap eliminating rotation hole. In this embodiment, the support assembly includes two side plates. The two outer shafts on the outer side are respectively located at the gap eliminating rotation holes of the two side plates and are rotatably connected thereto, thereby allowing the eccentric drive member to drive the eccentric shaft to be rotatably connected to the side plate.

In this embodiment, referring to FIGS. 1 to 3, the connecting assembly includes at least one abutment plate. The abutment plate is arranged between the two side plates, and an abutment notch is provided on the side surface of an end of the abutment plate close to the support assembly. A rotary curved surface is provided around the circumferential side of the inner shaft. When the eccentric shaft is rotated such that the rotary curved surface of the inner shaft is opposite the abutment notch, the abutment between the support assembly and the inner shaft is eliminated. This allows the support assembly to be rotatably connected to the connecting assembly, adjusting their relative placement angles. Thus, the relative angle between the support assembly and the connecting assembly can be changed, such that the cargo tool can be stored and occupy less space when not transporting items.

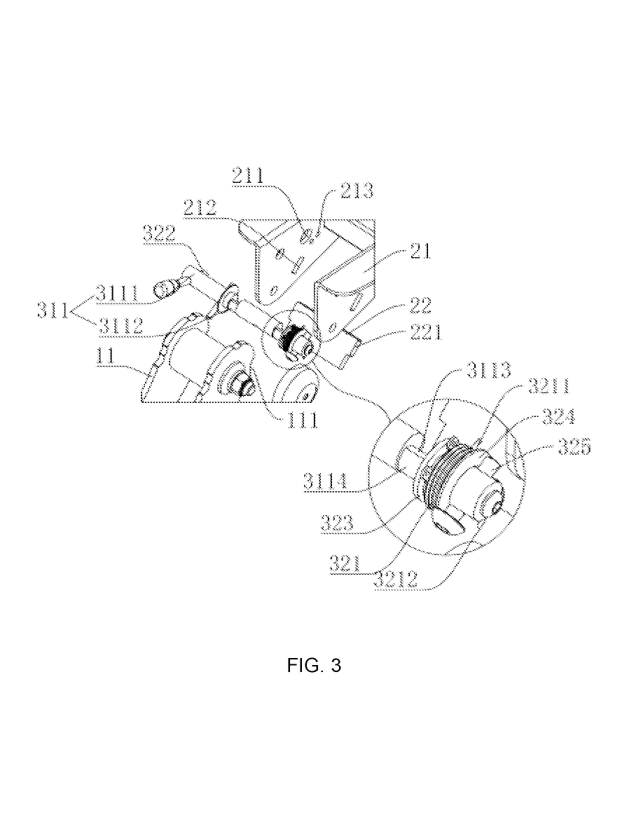

In this embodiment, referring to FIG. 3, the support assembly includes a support base plate arranged between the two side plates. The two ends of the support base plate are provided with support protruding arms. Each of the two side plates is provided with a support hole. The support protruding arms are clamped in the support holes, and the upper end surface of the support base plate abuts against the lower end surface of the abutment plate. Thus, the support base plate supports the weight of the support assembly and below the device.

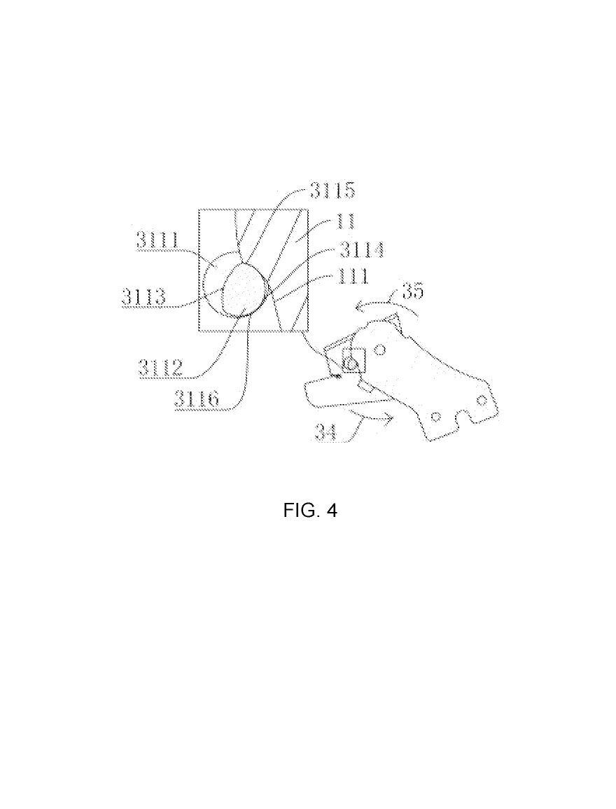

In this embodiment, referring to FIGS. 3 and 4, the circumferential side of the inner shaft is also provided with a gap-eliminating abutment surface. The gap-eliminating abutment surface is located on the other side of the rotary curved surface. The gap-eliminating abutment surface is used for abutting against the abutment notch, thereby exerting an upward force on the lower part of the abutment plate, eliminating the wear gap between the connecting assembly and the support assembly.

In this embodiment, referring to FIGS. 1 to 3, the eccentric drive member includes a drive torsion spring. The drive torsion spring is arranged on the outer side surface of the side plate and sleeves the outer shaft at one end of the eccentric shaft. The drive torsion spring is configured to drive the outer shaft of the eccentric shaft to rotate with the side plate, thereby driving the inner shaft to rotate along the first direction, eliminating the wear gap between the inner shaft and the side plate, and improving the overall structural stability of the cargo tool.

Further, referring to FIGS. 3 and 4, the drive torsion spring has one end provided with a first limiting hook and the other end provided with a second limiting hook. In this embodiment, the side plate is provided with a hook hole for mounting the first limiting hook, allowing one end of the drive torsion spring to be fixedly connected to the side plate via the first limiting hook and the hook hole. Additionally, the eccentric drive member further includes an isolation plate and a fixed plate that both sleeve the outer shaft of the eccentric shaft, and a torsion-spring fixing bolt that passes through the outer shaft of the eccentric shaft. Specifically, the isolation plate is located at one end of the drive torsion spring and located between the drive torsion spring and the side plate. The isolation plate can reduce wear caused by the abutment between the drive torsion spring and the side plate. The torsion-spring fixing bolt is located at the other end of the drive torsion spring, and the fixed plate is positioned between the torsion-spring fixing bolt and the drive torsion spring. The fixed plate can limit the drive torsion spring, preventing it from deforming along the axial direction of the eccentric shaft under pressure. Additionally, the torsion-spring fixing bolt passes through the outer shaft, allowing the second limiting hook to engage with the torsion-spring fixing bolt, thus fixing the other end of the drive torsion spring to the eccentric shaft via the torsion-spring fixing bolt. This drives the outer shaft of the eccentric shaft to rotate, further driving the inner shaft to rotate and eliminate the wear gap.

Further, referring to FIG. 4, the gap-eliminating abutment surface is provided with an abutment start point and an abutment end point. When the abutment start point abuts the abutment notch, the gap eliminating distance is 0 mm. When the drive torsion spring drives the eccentric shaft and the inner shaft to rotate such that the abutment end point abuts against the abutment notch, the gap eliminating distance is 3 mm. Specifically, when structures at both the abutment between the connecting assembly and the support assembly and the abutment between the eccentric member and the connecting assembly show signs of wear, the abutment start point on the gap-eliminating abutment surface abuts against the abutment notch of the abutment plate. When the structures at both the abutments wear and create gaps, the support assembly and the device, under the action of gravity, cause the support base plate to move downward around the rotational structure, keeping continuous abutment between the support base plate and the lower end surface of the abutment plate. In this case, a wear gap is caused between the abutment plate and the inner shaft, eliminating the abutment state between the inner shaft of the eccentric shaft and the abutment plate. The drive torsion spring can then drive the outer shaft of the eccentric shaft to rotate along the first direction. The structural arrangement of the eccentric misalignment of the inner shaft and the outer shaft drives the inner shaft to rotate continuously and abut against the abutment plate, thereby eliminating the wear gap therebetween.

In some embodiments, referring to FIGS. 1 to 3 and FIG. 5, the eccentric drive member includes a manual lever, and the manual lever passes through the outer shaft at the other end of the eccentric shaft. The manual lever is configured to shake the eccentric shaft, enabling the eccentric shaft to rotate along the second direction, so that the rotary curved surface corresponds to the abutment notch of the abutment plate. This eliminates the abutment between the support assembly and the inner shaft and is conducive to changing the relative angle between the support assembly and the connecting assembly, such that the support assembly of the cargo tool is stored, reducing the occupied space.

It should be understood that persons of ordinary skill in the art can make modifications or changes based on the above description, and all such modifications and changes should fall within the scope of protection of the appended claims of the present invention.

The above has provided an exemplary description of the present patent with reference to the drawings. It is evident that the implementation of the present patent is not limited to the above methods. Various modifications made using the method conceptions and technical solutions of the present patent, or direct applications of the conceptions and technical solutions of the present patent to other occasions without modification all fall within the protection scope of the present invention.

1. An externally connected cargo tool for a vehicle, comprising:
a connecting assembly, a support assembly, and an eccentric assembly disposed therebetween, the connecting assembly is rotatably connected to and abuts against the support assembly, the eccentric assembly comprises an eccentric member and an eccentric drive member, two ends of the eccentric member are both connected to the support assembly, and a middle portion of the eccentric member abuts against thee connecting assembly; and
the eccentric drive member is connected to both the support assembly and the eccentric member, and the eccentric drive member is configured to drive the eccentric member to rotate, eliminating a wear gap at an abutment between the eccentric member and the connecting assembly.

2. The externally connected cargo tool for a vehicle according to claim 1, wherein the eccentric member comprises an eccentric shaft, the eccentric shaft is provided with at least two outer shafts and an inner shaft between adjacent two of the outer shafts, an axis of the inner shaft is eccentrically arranged with respect to an axis of the outer shaft, the outer shaft is configured to be rotatably connected to the support assembly, and the inner shaft is configured to abut against the connecting assembly.

3. The externally connected cargo tool for a vehicle according to claim 2, wherein the support assembly comprises at least two side plates parallel to each other, the side plate is provided with a gap eliminating rotation hole, the eccentric shaft perpendicularly passes through the gap eliminating rotation hole, and the outer shaft is rotatably disposed in the gap eliminating rotation hole.

4. The externally connected cargo tool for a vehicle according to claim 3, wherein the connecting assembly comprises at least one abutment plate, the abutment plate is disposed between two of the side plates, and the abutment plate is provided with an abutment notch; and
a rotary curved surface is provided around a circumferential side of the inner shaft, when the eccentric shaft is rotated such that the rotary curved surface is opposite the abutment notch, an abutment between the support assembly and the inner shaft is eliminated, and the support assembly is rotatably connected to the connecting assembly so as to adjust a placement angle.

5. The externally connected cargo tool for a vehicle according to claim 4, wherein the support assembly further comprises a support base plate disposed between two of the side plates, and two ends of the support base plate are each provided with a support protruding arm; and
the side plate is provided with a support hole, the support protruding arm is clamped in the support hole, the support base plate abuts against a lower end surface of the abutment plate, and the support base plate is configured to support the weight of the support assembly.

6. The externally connected cargo tool for a vehicle according to claim 4, wherein a gap-eliminating abutment surface is also provided on the circumferential side of the inner shaft, and the gap-eliminating abutment surface is used for abutting against the abutment notch.

7. The externally connected cargo tool for a vehicle according to claim 6, wherein the eccentric drive member comprises a drive torsion spring, the drive torsion spring is disposed on an outer side of the side plate, the drive torsion spring sleeves an end of the outer shaft, and the drive torsion spring is configured to drive the eccentric shaft to rotate along a first direction, such that the inner shaft rotates to eliminate a wear gap.

8. The externally connected cargo tool for a vehicle according to claim 6, wherein an abutment start point and an abutment end point are provided on the gap-eliminating abutment surface, when the abutment start point abuts the abutment notch, a gap eliminating distance is 0 mm, and when the eccentric shaft rotates, enabling the abutment end point to abut the abutment notch, the gap eliminating distance is 3 mm.

9. The externally connected cargo tool for a vehicle according to claim 7, wherein the drive torsion spring has one end provided with a first limiting hook and the other end provided with a second limiting hook, the first limiting hook is fixedly connected to the side plate, and the second limiting hook is fixedly connected to the outer shaft.

10. The externally connected cargo tool for a vehicle according to claim 7, wherein the eccentric drive member further comprises a manual lever, the manual lever is connected to another end of the eccentric shaft, and the manual lever is configured to shake the eccentric shaft, enabling the eccentric shaft to rotate along a second direction.
